(19) United States
(12) Patent Application Publication
(10) Pub. No.: US 2015/0264269 A1
(43) Pub. Date: Sep. 17, 2015

(54) IMAGE-CAPTURING DEVICE AND METHOD FOR CORRECTING DEVIATED VIEWING ANGLE IN IMAGE CAPTURING

(71) Applicant: CHICONY ELECTRONICS CO., LTD., New Taipei City (TW)

(72) Inventors: Shang-Yuan Yuan, New Taipei City (TW); Mei-Yi Tsai, New Taipei City (TW); Wei-Cheng Huang, New Taipei City (TW)

(21) Appl. No.: 14/608,134

(22) Filed: Jan. 28, 2015

(30) Foreign Application Priority Data
Mar. 13, 2014 (TW) 103109106

(51) Int. Cl. H04N 5/232

(52) U.S. Cl. CPC H04N 5/23296; H04N 5/23229

(57) ABSTRACT

An image-capturing device and a method for correcting deviated viewing angle in image capturing are provided. The image-capturing method includes steps as follows. Image frames are captured with a default image-capturing viewing angle, and when a difference magnitude existing between a gravity-sensing inclination value and a reference axial direction is determined, the default image-capturing viewing angle is reversely adjusted for further capturing other image frames in accordance with the difference magnitude.

### RELATED APPLICATIONS

This application claims priority to Taiwanese Application Serial Number 103109106, filed Mar. 13, 2014, which is herein incorporated by reference.

### BACKGROUND

1. Field of Disclosure

The present disclosure relates to an image-capturing device and an image-capturing method for correcting deviated viewing angle in image capturing.

2. Description of Related Art

With the rapid development of information technology (IT), portable information products such as digital cameras, camcorders, mobile phones or alike are becoming more and more popular along with the trend toward compact size and light weight. In the portable information products, a wearable camera device (e.g., a camera device being installed on a piece of eyeglasses or a necklace) has been developed and even commercialized.

However, when in wearing a wearable camera device and shoots videos during traveling, it is not easy for an user to avoid from viewing-angle shifts happened by the human body of the user being inclined forwards and backwards and shaken, so that the portable information product may shoot videos with the deviated viewing angle which is not desired by the user.

Given the above, the aforementioned inconvenience and shortages are obviously existed so as to be further improved. Therefore, how to effectively solve the aforementioned inconvenience and shortages and to increase the competitiveness of industries shall be seriously concerned.

### SUMMARY

One aspect of this disclosure is to provide an image-capturing method and an image-capturing device for correcting deviated viewing angle in image capturing to solve the defects and inconvenience of the prior art, that is, by feedbacks that the inclination difference of the image-capturing device itself is sensed, the default image-capturing viewing angle of image frames which are desired to be captured can be reversely adjusted so as to possibly provide image frames captured with a previous default image-capturing viewing angle and to further decrease invalid image frames when the default image-capturing viewing angle is deviated.

For achieving the aforementioned object, according to one or more embodiments of this disclosure, the image-capturing method for correcting deviated viewing angle in image capturing includes the steps as follows. Image frames are captured with a default image-capturing viewing angle, and when a difference magnitude existing between a gravity-sensing inclination value and a reference axial direction is determined, the default image-capturing viewing angle is reversely adjusted for further capturing other image frames in accordance with the difference magnitude.

According to one or more embodiments of this disclosure, the step of reversely adjusting the default image-capturing viewing angle for further capturing the other image frames in accordance with the difference magnitude further includes the following steps. An instant image-capturing viewing angle of the image-capturing device is reversely shifted to become a first corrected image-capturing viewing angle being at least partially overlapping the default image-capturing viewing angle in accordance with the difference magnitude, so that the image-capturing device is allowed to further continuously capture the other image frames with the first corrected image-capturing viewing angle.

According to one or more embodiments of this disclosure, the step of reversely adjusting the default image-capturing viewing angle for further capturing the other image frames in accordance with the difference magnitude further includes the following steps. The instant image-capturing viewing angle is reversely rotated and shifted to become the first corrected image-capturing viewing angle in accordance with the difference magnitude.

According to one or more embodiments of this disclosure, the step of reversely adjusting the default image-capturing viewing angle for further capturing the other image frames in accordance with the difference magnitude further includes the following steps. An image capturing module of the image-capturing device is moved by a driving unit of the image-capturing device to reversely rotate and shift the instant image-capturing viewing angle to become the first corrected image-capturing viewing angle in accordance with the difference magnitude.

According to one or more embodiments of this disclosure, the image-capturing method for correcting deviated viewing angle further includes the following steps. After the image frame captured with the default image-capturing viewing angle, when a plurality of the gravity-sensing inclination values being further collected by the image-capturing device are determined to be the same and different to the reference axial direction, one of the gravity-sensing inclination values is set as the reference axial direction.

According to one or more embodiments of this disclosure, the image-capturing method for correcting deviated viewing angle further includes the following steps. A plurality of the gravity-sensing inclination values are collected, and an average value of the gravity-sensing inclination values is calculated out after the instant image-capturing viewing angle of the image-capturing device is reversely shifted to become the first corrected image-capturing viewing angle; and another instant image-capturing viewing angle of the image-capturing device is adjusted to become a second corrected image-capturing viewing angle in accordance with the average value, such that the image-capturing device is allowed to further continuously capture image frames with the second corrected image-capturing viewing angle.

According to one or more embodiments of this disclosure, the image-capturing method for correcting deviated viewing angle further includes the following steps. A plurality of the gravity-sensing inclination values are collected, and a calculation result of the gravity-sensing inclination values and a weight rule is calculated out after the instant image-capturing viewing angle of the image-capturing device is reversely shifted to become the first corrected image-capturing viewing angle; and another instant image-capturing viewing angle of the image-capturing device is adjusted to become a second corrected image-capturing viewing angle in accordance with the calculation result, such that the image-capturing device is allowed to further continuously capture image frames with the second corrected image-capturing viewing angle.

According to one or more embodiments of this disclosure, the step of the image frames are captured by the image-capturing device with a default image-capturing viewing angle further includes the following steps. A first sensitive pixel image is sensed by the image-capturing device, and a first clipped picture is obtained by clipping from the first sensitive pixel image in accordance with a default image-capturing region reflected correspondingly to the first sensitive pixel image.

According to one or more embodiments of this disclosure, when the default image-capturing viewing angle is reversely adjusted in accordance with the difference magnitude, the default image-capturing region is preset to be a central zone of the first sensitive pixel image.

According to one or more embodiments of this disclosure, the step of reversely adjusting the default image-capturing viewing angle in accordance with the difference magnitude further includes the following steps. A second sensitive pixel image is sensed by the image-capturing device; and the default image-capturing region reflected correspondingly to the second sensitive pixel image is reversely shifted in accordance with the difference magnitude, and a second clipped picture is obtained by clipping the reversely shifted default image-capturing region from the second sensitive pixel image.

According to one or more embodiments of this disclosure, the step of obtaining the second clipped picture further includes the following steps. After the second sensitive pixel image is sensed, the second sensitive pixel image is stored into a temporary memory, and the second clipped picture is obtained by clipping the reversely shifted default image-capturing region from the second sensitive pixel image in the temporary memory, and then the second clipped picture is stored in a non-volatile memory.

According to one or more embodiments of this disclosure, the step of obtaining the second clipped picture by clipping from the second sensitive pixel image further includes the following steps. After the second sensitive pixel image is sensed, the second sensitive pixel image is stored into a non-volatile memory, and the second clipped picture is obtained by clipping the reversely shifted default image-capturing region from the second sensitive pixel image in the non-volatile memory.

According to one or more embodiments of this disclosure, when the default image-capturing region is reversely shifted to an edge of the second sensitive pixel image, the edge of the second sensitive pixel image is redrawn before the second clipped picture is obtained by clipping from the second sensitive pixel image.

According to one or more embodiments of this disclosure, the image-capturing method for correcting deviated viewing angle further includes the following steps. After the first sensitive pixel image is sensed, when a plurality of the gravity-sensing inclination values being further collected by the image-capturing device are determined to be the same and different to the reference axial direction, one of the gravity-sensing inclination values is set as the reference axial direction.

According to one or more embodiments of this disclosure, the image-capturing method for correcting deviated viewing angle further includes the following steps. A plurality of the gravity-sensing inclination values are collected by the image-capturing device, and an average value of the gravity-sensing inclination values is calculated out after the second clipped picture is obtained; and a third sensitive pixel image is sensed by the image-capturing device, and the default image-capturing region reflected correspondingly to the third sensitive pixel image is reversely shifted in accordance with the average value, and a third clipped picture is obtained by clipping the reversely shifted default image-capturing region from the third sensitive pixel image.

According to one or more embodiments of this disclosure, the image-capturing method for correcting deviated viewing angle further includes the following steps. A plurality of the gravity-sensing inclination values are collected by the image-capturing device, and a calculation result of the gravity-sensing inclination values and a weight rule is calculated out after the second clipped picture is obtained; and the default image-capturing region reflected correspondingly to the third sensitive pixel image is reversely shifted in accordance with the calculation result, and a third clipped picture is obtained by clipping the reversely shifted default image-capturing region from the third sensitive pixel image.

The image-capturing method for correcting deviated viewing angle may be implemented by a program and stored in a computer readable storage medium. Thus, after a computer accesses the computer program, the computer is able to execute the image-capturing method.

Another aspect of this disclosure is to provide an image-capturing device for correcting deviated viewing angle in image capturing includes a main body, an image capturing module, a driving unit, a gravity sensing unit and a processing unit. The image capturing module is pivotally disposed on the main body, and operated for capturing image frames with a default image-capturing viewing angle. The driving unit is coupled to the image capturing module, and operated for shifting an instant image-capturing viewing angle of the image capturing module. The gravity sensing unit is disposed on the main body, and operated for sensing a gravity-sensing inclination value of the main body. The processing unit is electrically connected to the driving unit, the image capturing module and the gravity sensing unit. Whenever the processing unit determines that a difference magnitude exits between a reference axial direction and the gravity-sensing inclination value, the driving unit reversely shifts the instant image-capturing viewing angle of the image capturing module to become a corrected image-capturing viewing angle being at least partially overlapping the default image-capturing viewing angle in accordance with the difference magnitude, such that the image-capturing device is allowed to further continuously capture other image frames with the corrected image-capturing viewing angle.

The other aspect of this disclosure is to provide an image-capturing device for correcting deviated viewing angle in image capturing includes an image capturing module, a gravity sensing unit and a processing unit. The image capturing module is operated for sensing a first sensitive pixel image. The gravity sensing unit is operated for collecting a gravity-sensing inclination value. The processing unit is electrically connected to the image capturing module and the gravity sensing unit, and operated for obtaining a first clipped picture by clipping from the first sensitive pixel image in accordance with a default image-capturing region reflected correspondingly to the first sensitive pixel image. When the processing unit determines that a difference magnitude exits between a reference axial direction and the gravity-sensing inclination value, the processing unit reversely shifts the default image-capturing region reflected correspondingly to a second sensitive pixel image sensed by the image capturing module in accordance with the difference magnitude, and obtains a second clipped picture by clipping the reversely shifted default image-capturing region from the second sensitive pixel image.

It is to be understood that both the foregoing general description and the following detailed description are by examples, and are intended to provide further explanation of the disclosure as claimed.

### BRIEF DESCRIPTION OF THE DRAWINGS

The disclosure may be more fully understood by reading the following detailed description of the embodiment, with reference made to the accompanying drawings as follows:

FIG. 1 is a flow chart of an image-capturing method for correcting deviated viewing angle in image capturing according to a first embodiment of the disclosure;

FIG. 2A is a block diagram of an image-capturing device for correcting deviated viewing angle in image capturing according to the first embodiment of the disclosure;

FIG. 2B is a schematic appearance of an image-capturing device for correcting deviated viewing angle in image capturing according to the first embodiment of the disclosure;

FIG. 3A to FIG. 3B are operation schematic diagrams of an image-capturing device for correcting deviated viewing angle in image capturing according to the first embodiment of the disclosure;

FIG. 4 is a look-up table filling with gravity-sensing inclination values and average values according to the first embodiment of the disclosure;

FIG. 5 is a flow chart of an image-capturing method for correcting deviated viewing angle in image capturing according to a second embodiment of the disclosure;

FIG. 6A to FIG. 6B are operation schematic diagrams of an image-capturing device for correcting deviated viewing angle in image capturing according to the second embodiment of the disclosure; and

FIG. 7 is a block diagram of an image-capturing device for correcting deviated viewing angle in image capturing according to the second embodiment of the disclosure.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts. According to the embodiments, it will be apparent to those skilled in the art that various modifications and variations can be made to the structure of the present disclosure without departing from the scope or spirit of the disclosure.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

In the image-capturing method for correcting deviated viewing angle in image capturing of the disclosure, by feedbacks that the inclination difference of the image-capturing device itself is sensed, the default image-capturing viewing angle of image frames which are desired to be captured can be reversely adjusted so as to possibly provide image frames captured with a previous default image-capturing viewing angle and to further decrease invalid image frames when the default image-capturing viewing angle is deviated. The image-capturing device for correcting deviated viewing angle in image capturing of the disclosure is not limited to types thereof, and can be, for example, camera devices, mobile phones, tablet computers, wearable portable devices or alike.

The image-capturing method for correcting deviated viewing angle in image capturing of the disclosure may be implemented by a computer program product in which the computer program product has at least one computer program (including software or firmware), and the computer program can be stored in a computer readable storage medium. Accordingly, when the computer program is downloaded into an image-capturing device, the computer program allows the image-capturing device to execute the image-capturing method for correcting deviated viewing angle in image capturing. The computer program product can be stored in a read-only memory, a flash memory, a floppy disk, a hard disk, a CD-ROM, a portable disk, a magnetic tape, or by accessing the database network who are familiar with this skill can easily think of a computer and have the same functionality can be readable recording medium.

### First Embodiment

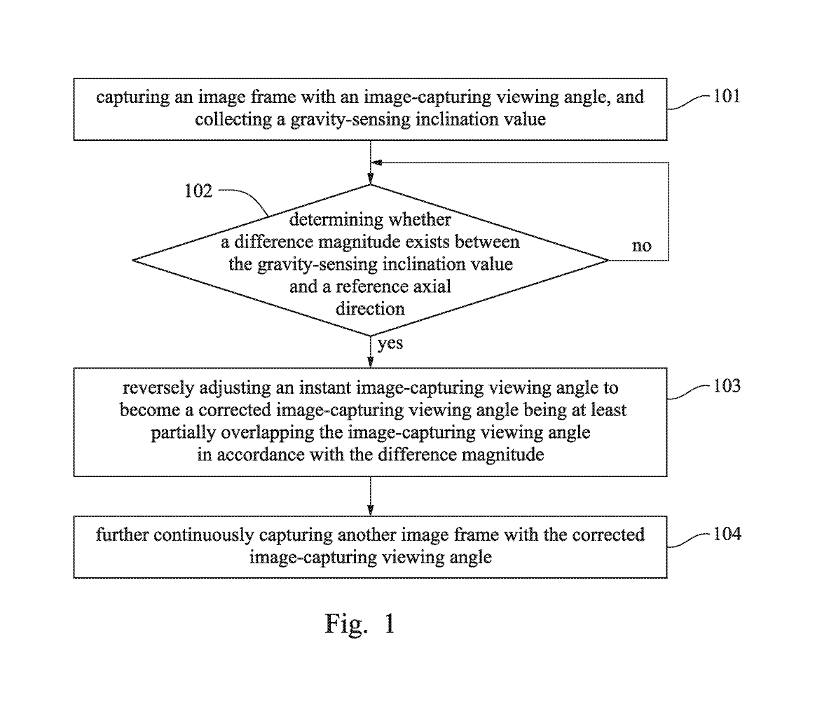

FIG. 1 is a flow chart of an image-capturing method for correcting deviated viewing angle in image capturing according to a first embodiment of the disclosure. As shown in FIG. 1, the image-capturing method includes the following steps. In step 101, an image-capturing device is used to capture an image frame with an image-capturing viewing angle, and to collect a gravity-sensing inclination value. In step 102, a determination is made as to whether a difference magnitude exists between a gravity-sensing inclination value and a reference axial direction, if yes, go to step 103; or back to step 102. In step 103, the image-capturing device is used to reversely adjust (e.g., shift) an instant image-capturing viewing angle to become a corrected image-capturing viewing angle being at least partially overlapping the image-capturing viewing angle in accordance with the difference magnitude. In step 104, the image-capturing device is used to further continuously capture another image frame with the corrected image-capturing viewing angle.

Thus, although a user wearing the image-capturing device may tilt or shake to non-intentionally cause the image frame deviated, the image frames captured with the previous default image-capturing viewing angle might be temporarily missed. Thus, the default image-capturing viewing angle of image frames which are desired to be captured can be reversely adjusted so as to possibly provide image frames captured with a previous default image-capturing viewing angle and to further decrease invalid image frames when the default image-capturing viewing angle is deviated.

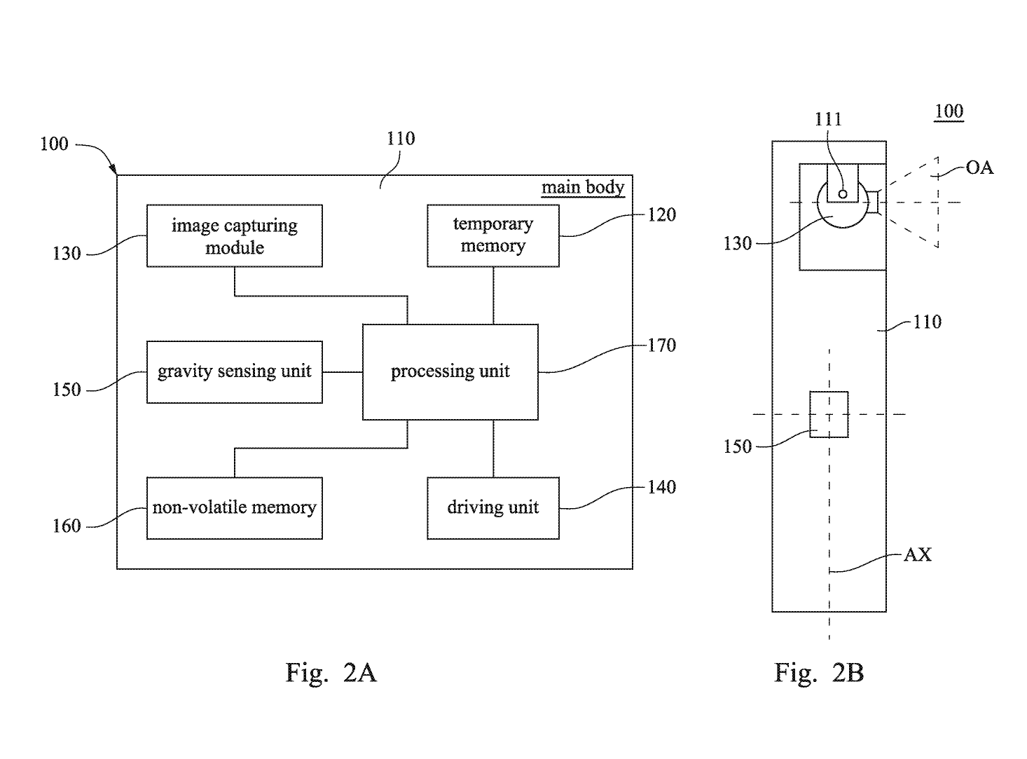

Reference is now made to FIG. 2A and FIG. 2B in which FIG. 2A is a block diagram of an image-capturing device for correcting deviated viewing angle in image capturing according to the first embodiment of the disclosure, and FIG. 2B is a schematic appearance of an image-capturing device for correcting deviated viewing angle in image capturing according to the first embodiment of the disclosure. As shown in FIG. 2A and FIG. 2B, the image-capturing device 100 includes a main body 110, a temporary memory 120 (e.g., Dynamic Random Access Memory, DRAM), an image capturing module 130, a driving unit 140, a gravity sensing unit 150, a non-volatile memory 160 and a processing unit 170. The processing unit 170 is electrically connected to the temporary memory 120, the driving unit 140, the non-volatile memory 160, the image capturing module 130 and the gravity sensing unit 150. The image capturing module 130 is pivotally disposed on the main body 110. The image capturing module 130 can be operated to continually capture image frames with a default image-capturing viewing angle OA. The image frames are sequentially transmitted to the temporary memory 120, and the image frames are then sequentially transmitted to the non-volatile memory 160 finally. The non-volatile memory 160, for example, can be a read-only memory, a flash memory, a floppy disk, a hard disk, a CD-ROM, a portable disk, a magnetic tape, or a database network being accessible via networks. The driving unit 140 is coupled to the image capturing module 130, and operated for adjusting (e.g., shifting) an instant image-capturing viewing angle of the image capturing module 130. The gravity sensing unit 150 is disposed on the main body 110, and operated for periodically sensing and collecting gravity-sensing inclination values GA of the main body 110 as the main body 110 is in a tilt state.

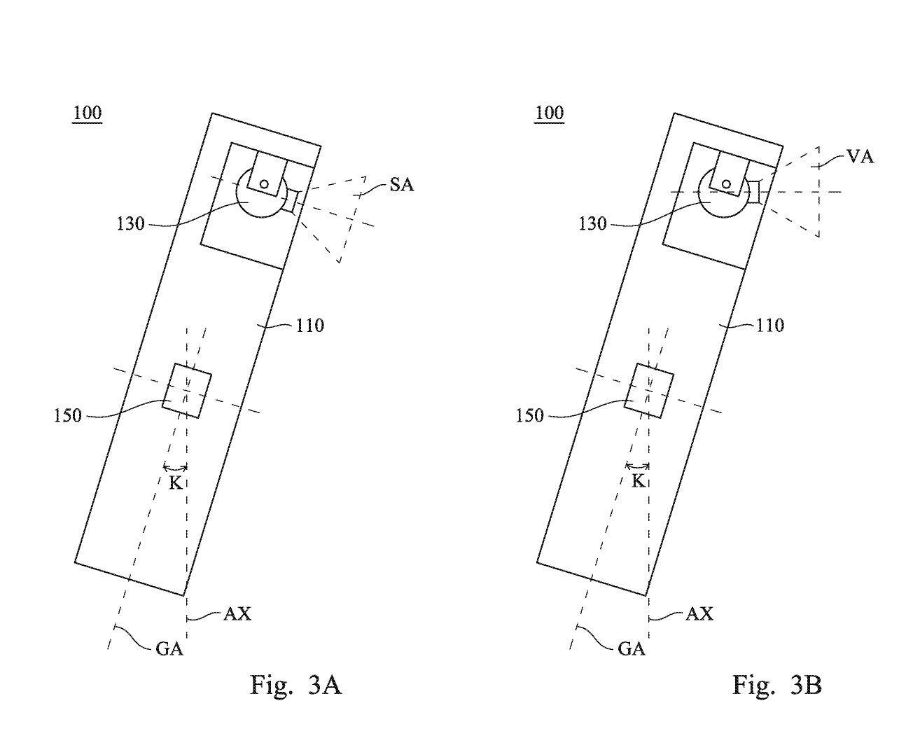

Reference is now made to FIG. 3A and FIG. 3B in which FIG. 3A to FIG. 3B are operation schematic diagrams of an image-capturing device 100 for correcting deviated viewing angle in image capturing according to the first embodiment of the disclosure. As shown in FIG. 2A and FIG. 3A, whenever the body of the user sways or shakes to tilt the main body 110 of the image-capturing device 100, the instant image-capturing viewing angle SA of the image capturing module 130 is adjusted (e.g., shifted) unintendedly.

In the regard, once the processing unit 170 determines that a difference magnitude K exits between a reference axial direction AX and the gravity-sensing inclination value GA collected by the gravity sensing unit 150 at this moment, as shown in FIG. 3B, the processing unit 170 rotates the image capturing module 130 to reversely adjust (e.g., shift) the instant image-capturing viewing angle SA of the image capturing module 130 to become a first corrected image-capturing viewing angle VA in accordance with the difference magnitude K. The reference axial direction AX of the first embodiment normally is preset as an axial direction (z-axis) of gravity, however, the disclosure is not limited thereto.

Specifically, the processing unit 170 instantly requests the driving unit 140 to reversely rotate the image capturing module 130 in accordance with the proportion of the difference magnitude K so that the instant image-capturing viewing angle SA is adjusted (e.g., shifted) to become the first corrected image-capturing viewing angle VA. The first corrected image-capturing viewing angle can completely overlap the default image-capturing viewing angle OA, or at least partially overlap the default image-capturing viewing angle OA, or may be not overlap, but at least extremely adjacent to, the default image-capturing viewing angle OA. Thus, since the first corrected image-capturing viewing angle VA of the image capturing module 130 is instantly corrected back to the default image-capturing viewing angle OA, the image capturing module 130 can continue to capture image frames with the first corrected image-capturing viewing angle VA so as to possibly provide image frames captured with a previous default image-capturing viewing angle and to further decrease invalid image frames when the default image-capturing viewing angle is deviated.

It is noted, the angle that the image capturing module 130 is reversely rotated can be completely equal to the angle of the difference magnitude K, or close to the angle of the difference magnitude K, for example, 60%-99% to cooperate the flexibility of the driving unit 140. The driving unit 140 is not limited to a motor apparatus, a solenoid valve or other conventional power-driven device. The motor device for example can be a linear motor, a step motor, a servo motor or a voice coil motor and the like.

Back to FIG. 2A, the image capturing module 130 is pivoted to the main body 110 through a rotation shaft 111, however, in one of other embodiments, the image capturing module also can be universally and movably coupled to the main body 110 through a globular universal joint. Thus, by rotating on the globular universal joint, the image capturing module can be operated to perform multi-directional rotations, i.e., the way that a ball rotates, relative to the main body.

Refer to FIG. 2A and FIG. 3A, although the reference axial direction AX of the first embodiment is normally preset as the axial direction (z-axis) of gravity, however, the reference axial direction AX is not unchangeable. In a part of the first embodiment, for providing more human-centered applications, in the following operations, when the processing unit 170 determines that the recent gravity-sensing inclination values GA being further collected by the gravity sensing unit 150 in a specific number or during a specific period are obviously different to the reference axial direction AX, and are substantially similar with each other or even completely the same, the processing unit 170 instantly sets one of these gravity-sensing inclination values GA as the reference axial direction AX.

Therefore, once the gravity-sensing inclination value GA is rectified and set as the reference axial direction AX, when another gravity-sensing inclination value GA being similar to those aforementioned gravity-sensing inclination values GA is further subsequently detected ever again, the difference magnitude K defined between this gravity-sensing inclination value GA and the reset reference axial direction will not be too wide so that the time that the image capturing module 130 is reversely rotated for instantly forming the first corrected image-capturing viewing angle VA can be reduced, and the flexibility that the image capturing module 130 rotates can be enhanced.

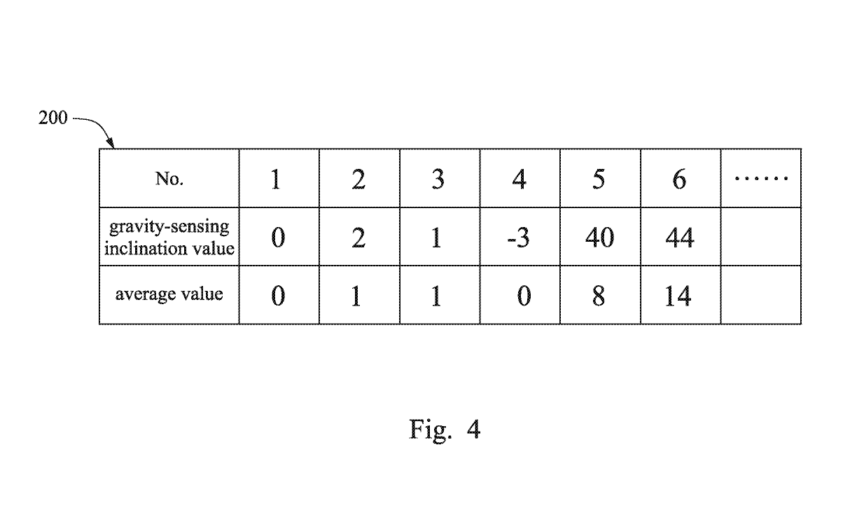

Furthermore, when the user intends to change the default image-capturing viewing angle OA, in order to reset the default image-capturing viewing angle OA without manually operating the image-capturing device 100 for providing more human-centered applications, in another part of the first embodiment, as shown in FIG. 4, FIG. 4 is a look-up table 200 filling with gravity-sensing inclination values and average values according to the first embodiment of the disclosure. To avoid visual discomfort caused from viewing the captured image frames due to the difference magnitude K being overly large, when the gravity sensing unit 150 subsequently collects a plurality of the gravity-sensing inclination values GA, the processing unit 170 calculates out an average value of the gravity-sensing inclination values GA, and reversely adjusts (e.g., shifts) the instant image-capturing viewing angle SA of the image capturing module 130 to become a second corrected image-capturing viewing angle in accordance with the average value, rather than the difference magnitude K. Accordingly, the image-capturing device 100 continues to capture image frames with the second corrected image-capturing viewing angle.

For example, the average value of the gravity-sensing inclination values GA being collected in the first time and the second time is 1 [(0+2)/2], the average value of the gravity-sensing inclination values GA being collected from the first time to the third time is 1 [(0+2+1)/3], . . . , the average value of the gravity-sensing inclination values GA being collected from the first time to the fifth time is 8 [(0+2+1−3+40)/5] and the average value of the gravity-sensing inclination values GA being collected from the first time to the sixth time is 14[(0+2+1−3+40+44)/6]. Thus, respect to the gravity-sensing inclination value GA (0° or 2° being collected in the first time or the second time, although the gravity-sensing inclination value GA (40° or 44° being collected in the fifth time or the sixth time is quite distinguished, by using the aforementioned average value as reference, the rotation magnitude that the image capturing module 130 being rotated can be moderated so as to reduce the visual discomfort brought from viewing the captured image frames. Regarding to the calculation of the average value described above, for example, every two or three sets of data might be seen as a single unit for calculation, or can be adjusted according to the demands, however, the calculation of the average value described above is not limited in the disclosure.

Also, other than the calculation of the average value of the gravity-sensing inclination values described above, in one of other embodiments, the calculation of weight rules of the gravity-sensing inclination values also can be adopted. When the gravity sensing unit 150 subsequently collects a plurality of the gravity-sensing inclination values GA, the processing unit 170 calculates out a calculation result of the gravity-sensing inclination values GA and a weight rule, and reversely adjusts (e.g., shifts) another instant image-capturing viewing angle SA of the image capturing module 130 as a second corrected image-capturing viewing angle in accordance with the calculation result so that the image-capturing device 100 can continue to capture image frames with the second corrected image-capturing viewing angle.

For another example with data of the look-up table 200 in FIG. 4, the calculation results of the gravity-sensing inclination values GA being collected in the first time and the second time is 0.7 [(0*0.3+2*0.7)/2], the calculation results of the gravity-sensing inclination values GA being collected from the first time to the third time is 0.43 [(0+2)*0.3+(1*0.7)/3], . . . , the calculation results of the gravity-sensing inclination values GA being collected from the first time to the fifth time is 5.6 [(0+2+1−3)*0.3+(40*0.7)/5] and the calculation results of the gravity-sensing inclination values GA being collected from the first time to the sixth time is 7.13 [(0+2+1−3+40)*0.3+(44*0.7)/6]. Therefore, with the aforementioned calculation result, the data can be closer to the practical condition, and the rotation magnitude that the image capturing module 130 being rotated can be moderated so as to reduce the visual discomfort brought from viewing the captured image frames. Regarding to the calculation of the average value described above, for example, every two or three sets of data might be seen as a single unit for calculation, or can be adjusted according to the demands, however, the calculation of weight rules of the gravity-sensing inclination values described above is not limited in the disclosure.

### Second Embodiment

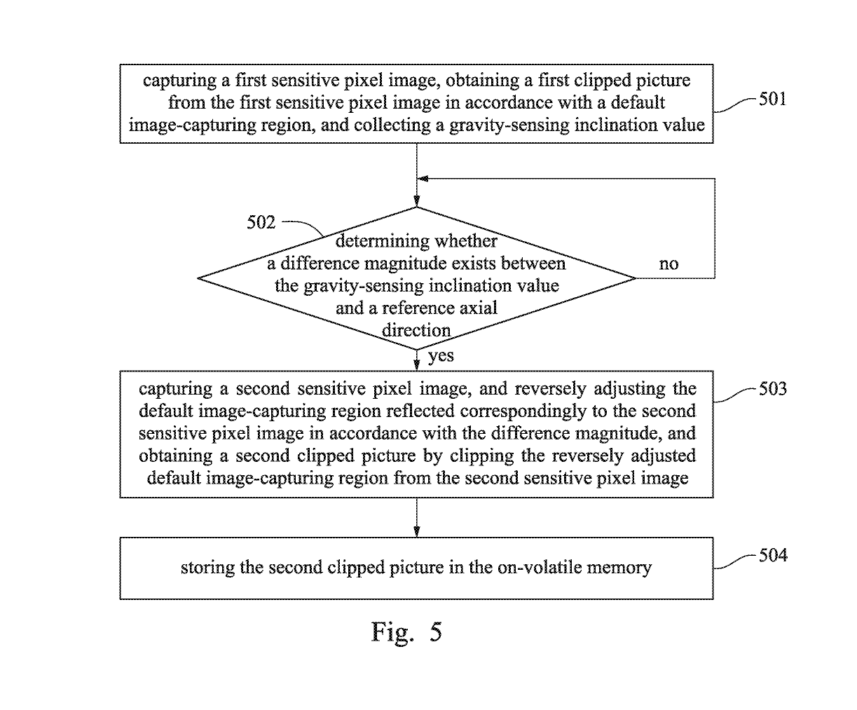

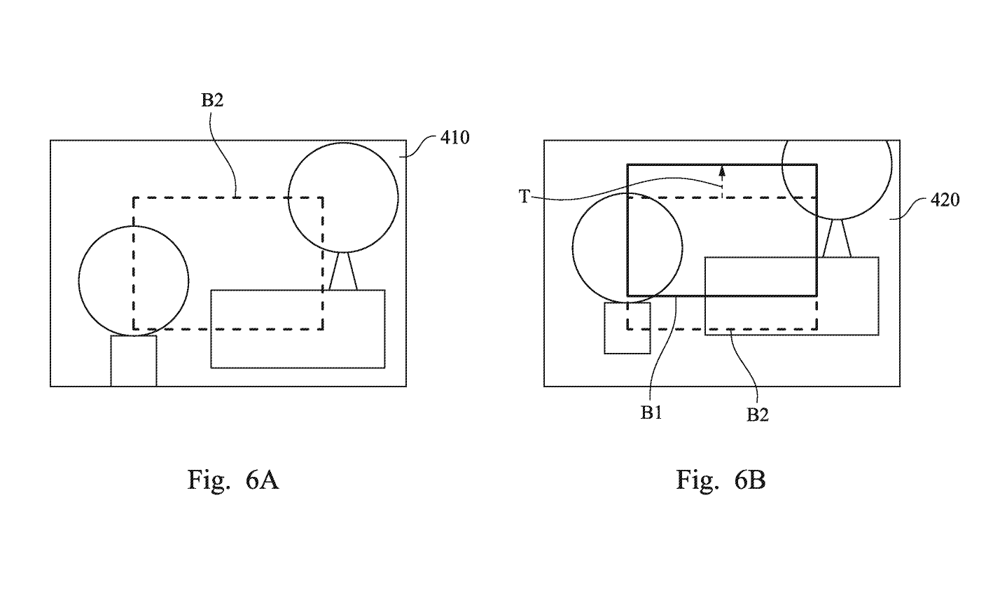

Reference is now made to FIG. 5, FIGS. 6A-6B in which FIG. 5 is a flow chart of an image-capturing method for correcting deviated viewing angle in image capturing according to a second embodiment of the disclosure, and FIG. 6A to FIG. 6B are operation schematic diagrams of an image-capturing device for correcting deviated viewing angle in image capturing according to the second embodiment of the disclosure.

As shown in FIG. 5 and FIG. 6A, the image-capturing method includes the following steps 501 to 504. In step 501, the image-capturing device 300 is used to capture (e.g., sense) a first sensitive pixel image 410, and obtains a first clipped picture (refer to the dotted box B2 of FIG. 6A) by clipping from the first sensitive pixel image 410 in accordance with a default image-capturing region (see as the dotted box B2 of FIG. 6A) reflected correspondingly to the first sensitive pixel image 410. Before step 502, a gravity-sensing inclination values GA is collected, and in step 502, a determination is made as to whether a difference magnitude K (refer to FIG. 3A) exists between the gravity-sensing inclination value GA (refer to FIG. 3A) and a reference axial direction AX (refer to FIG. 3A), if yes, go to step 503; or back to step 502. In step 503, as shown in FIG. 6B, the image-capturing device 300 is used to capture (e.g., sense) a second sensitive pixel image 420, and reversely adjusts (e.g., shift) the aforementioned default image-capturing region (see as the dotted box B1 of FIG. 6B) reflected correspondingly to the second sensitive pixel image 420 in accordance with the difference magnitude (refer to the arrow T), and to obtain a second clipped picture (see as the dotted box B1 of FIG. 6B) by clipping the default image-capturing region being reversely adjusted already from the second sensitive pixel image 420. In step 504, the second clipped picture (see as the dotted box B1 of FIG. 6B) is stored.

Thus, although a user wearing the image-capturing device may tilt or shake to non-intentionally cause the image frame deviated to provide the second sensitive pixel image which is different the first sensitive pixel image so that the image frames captured with the default image-capturing region might be temporarily missed. Thus, the default image-capturing region reflected correspondingly to the second sensitive pixel image can be reversely adjusted by the image-capturing device so as to possibly provide a second clipped picture being similar to the first clipped picture to further decrease invalid image frames when the default image-capturing viewing angle is deviated.

Specifically, in step 501, the aforementioned default image-capturing region represents as a set of default coordinates, and by clipping from the first sensitive pixel image 410 in accordance with the set of default coordinates, the first clipped picture (refer to the dotted box B2 of FIG. 6A) can be obtained. The area size of the first clipped picture (refer to the dotted box B2 of FIG. 6A) is smaller than the area size of the first sensitive pixel image 410. Also, the first clipped picture, i.e., the default image-capturing region (refer to the dotted box B2 of FIG. 6A) can be preset to be a central zone of the first sensitive pixel image 410.

In step 503, the image-capturing device is provided with a reference table therein. The reference table includes a number of inclination values and pixel shifting values in which each of the inclination values corresponds to one of the pixel shifting values. For example, when one of the inclination values is “+5”, the corresponding one of the pixel shifting values is “+100” (i.e., the default image-capturing region is upwardly shifted 100 pixels), or when another is “−3”, the corresponding one of the pixel shifting values is “−60” (i.e., the default image-capturing region is downwardly shifted 60 pixels). Thus, in step 503, when the default image-capturing region (see as the dotted box B1) is reversely shifted on the second sensitive pixel image 420, according to the inclination value and the pixel shifting value which are corresponded with each other, the default image-capturing region (see as the dotted box B1) can be further moved by using the default coordinates reflected correspondingly to the second sensitive pixel image 420 with the corresponding pixel shifting value.

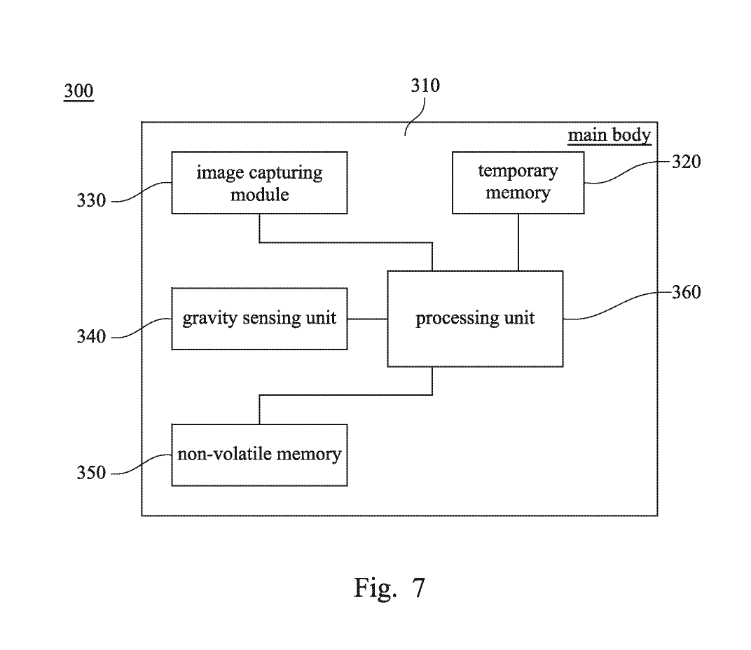

FIG. 7 is a block diagram of an image-capturing device for correcting deviated viewing angle in image capturing according to the second embodiment of the disclosure. As shown in FIG. 7, the image-capturing device 300 includes a main body 310, a temporary memory 320 (e.g., Dynamic Random Access Memory, DRAM), an image capturing module 330, a gravity sensing unit 340, a non-volatile memory 350 and a processing unit 360. The processing unit 360 is electrically connected to the temporary memory 320, the non-volatile memory 350, the image capturing module 330 and the gravity sensing unit 340. The image capturing module 330 is disposed on the main body 310. The gravity sensing unit 340 is disposed on the main body 310, and operated for periodically sensing and collecting gravity-sensing inclination values of the main body 310 as the main body 310 is in a tilt state.

The image capturing module 330 can be operated to sense sensitive pixel images, specifically, the sensitive pixel images can be sensed on a light-sensitive element (not shown in figures) of the image capturing module 330. For example, the light-sensitive element can be a charge coupled device (CCD) or a complementary metal-oxide semiconductor (CMOS). The temporary memory and the non-volatile memory mentioned above can be integrated in a same element in the actual practice; however, the disclosure is not limited thereto.

The second embodiment is substantially the same as the first embodiment, except that one of the differences of the embodiments is that the image capturing module 330 of the image-capturing device 300 is not needed to be pivotally installed on the main body 310, and the driver unit also is not needed for rotating the image capturing module 330. Particularly, since the resolutions (e.g., 4160*3120) of the first sensitive pixel image 410 is greater than the resolutions (e.g., 1920*1080) of the first clipped picture (refer to the dotted box B2 of FIG. 6A), and the default image-capturing region is normally preset to be a central zone of the first sensitive pixel image 410. Thus, in those steps above, after the image capturing module 330 senses the first sensitive pixel image 410 and stores the first sensitive pixel image 410 into the temporary memory 320, when the processing unit 360 determines that the aforementioned reference axial direction is the same, or at least substantially the same with a gravity-sensing inclination value GA collected by the gravity sensing unit 340 at this moment, the processing unit 360 partially clips out the first clipped picture (refer to the dotted box B2 of FIG. 6A) from the default image-capturing region reflected correspondingly to the first sensitive pixel image 410 stored in the temporary memory 320, and the processing unit 360 stores the first clipped picture to the non-volatile memory 350.

Similarly, in step 503, after the image capturing module 330 senses the second sensitive pixel image 420 and stores the second sensitive pixel image 420 into the temporary memory 320, the processing unit 360 reversely shifts the default image-capturing region and correspondingly reflects the reversely shifted default image-capturing region to the second sensitive pixel image 420 stored in the temporary memory 320, and the processing unit 360 partially clips out the second clipped picture (refer to the dotted box B1 of FIG. 6B) from the reversely shifted default image-capturing region of the second sensitive pixel image 420.

However, in one of other embodiments, it also works that after the image-capturing device 300 stores the second sensitive pixel image 420 into the non-volatile memory 350, the second clipped picture (refer to the dotted box B1 of FIG. 6B) is then partially clipped out from the second sensitive pixel image 420. After that, the second clipped picture (refer to the dotted box B1 of FIG. 6B) is then stored into the non-volatile memory 350. Regarding to another method for clipping out the second clipped picture (refer to the dotted box B1 of FIG. 6B), the processing unit 360 also can be used to directly control the image capturing module 330 for directly generating the second clipped picture (refer to the dotted box B1 of FIG. 6B), however, in actual practice, this embodiment is not limited thereto.

In a part of the second embodiment, since edges of the second sensitive pixel image 420 may be deformed or distorted, thus, in step 503, when the processing unit 360 reversely shifts the default image-capturing region to one of the edges of the second sensitive pixel image 420, before the processing unit 360 obtains the second clipped picture (refer to the dotted box B1 of FIG. 6B) on the second sensitive pixel image 420, the processing unit 360 redraws the edge of the second sensitive pixel image 420 through image processing algorithms.

Although the reference axial direction mentioned above is normally preset as the axial direction (z-axis) of gravity, however, the reference axial direction is not unchangeable. In a part of the second embodiment, for providing more human-centered applications, in the following operations, when the processing unit 360 determines that the recent gravity-sensing inclination values being further collected by the gravity sensing unit 340 in a specific number or during a specific period are obviously different to the reference axial direction, and are substantially similar with each other or even completely the same, the processing unit 360 can instantly set anyone of these gravity-sensing inclination values above as the reference axial direction.

Therefore, once the gravity-sensing inclination value GA is rectified and set as the reference axial direction AX, when another gravity-sensing inclination value GA being similar to those aforementioned gravity-sensing inclination values GA is further subsequently detected ever again, the difference magnitude K defined between this gravity-sensing inclination value GA and the reset reference axial direction will not be too wide so that the time that the default image-capturing region is reversely shifted on the second sensitive pixel image 420 by the processing unit 360 can be reduced, and resources for the processing unit 360 can be reduced.

Furthermore, when the user intends to change the default image-capturing region, in order to reset the default image-capturing region without manually operating the image-capturing device 300 for providing more human-centered applications, as shown in FIG. 6B, to avoid visual discomfort caused from viewing the captured image frames when a difference exits between the first clipped picture (refer to the dotted box B2 of FIG. 6A) and the second clipped picture (refer to the dotted box B1 of FIG. 6B) is overly large , in another part of the second embodiment, when the gravity sensing unit 340 subsequently collects a plurality of the gravity-sensing inclination values, and the processing unit 360 calculates out an average value of the gravity-sensing inclination values, the image capturing module 330 senses another sensitive pixel image (called as third sensitive pixel image hereinafter) in accordance with the average value, rather than the difference magnitude mentioned above. Next, the default image-capturing region reflected correspondingly to the third sensitive pixel image is reversely shifted for obtaining a third clipped picture by clipping the reversely shifted default image-capturing region from the third sensitive pixel image. Therefore, with the aforementioned average value, the difference magnitude that the default image-capturing region being shifted on the third sensitive pixel image can be moderated so as to reduce the visual discomfort brought from viewing the captured image frames.

Also, other than the calculation of the average value of the gravity-sensing inclination values described above, in one of other embodiments, the calculation of weight rules of the gravity-sensing inclination values also can be adopted. When the gravity sensing unit 340 subsequently collects a plurality of the gravity-sensing inclination values, the processing unit 360 calculates out a calculation result of the gravity-sensing inclination values and a weight rule. The image capturing module 330 further senses another sensitive pixel image (called as third sensitive pixel image hereinafter) in accordance with the calculation result, rather than the difference magnitude mentioned above. Next, the default image-capturing region reflected correspondingly to the third sensitive pixel image is reversely shifted for obtaining a third clipped picture by clipping the reversely shifted default image-capturing region from the third sensitive pixel image. Therefore, with the aforementioned calculation result, the data can be closer to the practical condition, the difference magnitude that the default image-capturing region being shifted on the third sensitive pixel image can be moderated so as to reduce the visual discomfort brought from viewing the captured image frames.

To sum up, according to the skill evaluation method of this disclosure, not only the professional skill of a learner is analyzed during the online learning process, but also the soft skill of the learner is analyzed from his community interaction with others online. This method provides the learner with self-skill analysis and benefits his future application.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of the disclosure provided they fall within the scope of the following claims and their equivalents.

What is claimed is:

1. An image-capturing method for correcting deviated viewing angle in image capturing comprising:
capturing image frames with a default image-capturing viewing angle by an image-capturing device; and
when a difference magnitude existing between a gravity-sensing inclination value collected by the image-capturing device and a reference axial direction is determined, reversely adjusting the default image-capturing viewing angle for further capturing other image frames in accordance with the difference magnitude.

2. The image-capturing method for correcting deviated viewing angle in image capturing of claim 1, wherein the step of reversely adjusting the default image-capturing viewing angle for further capturing the other image frames in accordance with the difference magnitude comprises:
reversely shifting an instant image-capturing viewing angle of the image-capturing device to become a first corrected image-capturing viewing angle being at least partially overlapping the default image-capturing viewing angle in accordance with the difference magnitude, such that the image-capturing device is allowed to further continuously capture the other image frames with the first corrected image-capturing viewing angle.

3. The image-capturing method for correcting deviated viewing angle in image capturing of claim 2, wherein the step of reversely adjusting the default image-capturing viewing angle for further capturing the other image frames in accordance with the difference magnitude further comprises:
reversely rotating and shifting the instant image-capturing viewing angle to become the first corrected image-capturing viewing angle in accordance with the difference magnitude.

4. The image-capturing method for correcting deviated viewing angle in image capturing of claim 3, wherein the step of reversely adjusting the default image-capturing viewing angle for further capturing the other image frames in accordance with the difference magnitude further comprises:
moving an image capturing module of the image-capturing device by a driving unit of the image-capturing device to reversely rotate and shift the instant image-capturing viewing angle to become the first corrected image-capturing viewing angle in accordance with the difference magnitude.

5. The image-capturing method for correcting deviated viewing angle in image capturing of claim 1, wherein the reference axial direction is an axial direction of gravity.

6. The image-capturing method for correcting deviated viewing angle in image capturing of claim 1, further comprising:
after the image frames captured with the default image-capturing viewing angle, when a plurality of the gravity-sensing inclination values being further collected by the image-capturing device are determined to be the same and different to the reference axial direction, setting one of the gravity-sensing inclination values as the reference axial direction.

7. The image-capturing method for correcting deviated viewing angle in image capturing of claim 2, further comprising:
collecting a plurality of the gravity-sensing inclination values, and calculating out an average value of the gravity-sensing inclination values after the instant image-capturing viewing angle of the image-capturing device is reversely shifted to become the first corrected image-capturing viewing angle; and
adjusting another instant image-capturing viewing angle of the image-capturing device to become a second corrected image-capturing viewing angle in accordance with the average value, such that the image-capturing device is allowed to further continuously capture image frames with the second corrected image-capturing viewing angle.

8. The image-capturing method for correcting deviated viewing angle in image capturing of claim 2, further comprising:
collecting a plurality of the gravity-sensing inclination values, and calculating out a calculation result of the gravity-sensing inclination values and a weight rule after the instant image-capturing viewing angle of the image-capturing device is reversely shifted to become the first corrected image-capturing viewing angle; and
adjusting another instant image-capturing viewing angle of the image-capturing device to be a second corrected image-capturing viewing angle in accordance with the calculation result, such that the image-capturing device is allowed to further continuously capture image frames with the second corrected image-capturing viewing angle.

9. The image-capturing method for correcting deviated viewing angle in image capturing of claim 1, wherein the step of capturing the image frames by the image-capturing device with a default image-capturing viewing angle comprises:
sensing a first sensitive pixel image by the image-capturing device, and obtaining a first clipped picture by clipping from the first sensitive pixel image in accordance with a default image-capturing region reflected correspondingly to the first sensitive pixel image.

10. The image-capturing method for correcting deviated viewing angle in image capturing of claim 9, wherein, when the default image-capturing viewing angle is reversely adjusted in accordance with the difference magnitude, the default image-capturing region is preset to be a central zone of the first sensitive pixel image.

11. The image-capturing method for correcting deviated viewing angle in image capturing of claim 9, wherein the step of reversely adjusting the default image-capturing viewing angle in accordance with the difference magnitude further comprises:
sensing a second sensitive pixel image by the image-capturing device; and
reversely shifting the default image-capturing region reflected correspondingly to the second sensitive pixel image in accordance with the difference magnitude, and obtaining a second clipped picture by clipping the reversely shifted default image-capturing region from the second sensitive pixel image.

12. The image-capturing method for correcting deviated viewing angle in image capturing of claim 11, wherein the step of obtaining the second clipped picture by clipping the reversely shifted default image-capturing region from the second sensitive pixel image further comprises:
after the second sensitive pixel image is sensed, the second sensitive pixel image is stored into a temporary memory, and the second clipped picture is obtained by clipping the reversely shifted default image-capturing region from the second sensitive pixel image in the temporary memory, and then the second clipped picture is stored in a non-volatile memory.

13. The image-capturing method for correcting deviated viewing angle in image capturing of claim 11, wherein the step of obtaining the second clipped picture by clipping the reversely shifted default image-capturing region from the second sensitive pixel image further comprises:
after the second sensitive pixel image is sensed, the second sensitive pixel image is stored into a non-volatile memory first, and the second clipped picture is obtained by clipping the reversely shifted default image-capturing region from the second sensitive pixel image in the non-volatile memory.

14. The image-capturing method for correcting deviated viewing angle in image capturing of claim 11, wherein when the default image-capturing region is reversely shifted to an edge of the second sensitive pixel image, redrawing the edge of the second sensitive pixel image before the second clipped picture is obtained.

15. The image-capturing method for correcting deviated viewing angle in image capturing of claim 11, further comprising:
after the first sensitive pixel image is sensed, when a plurality of the gravity-sensing inclination values being further collected by the image-capturing device are determined to be the same and different to the reference axial direction, setting one of the gravity-sensing inclination values as the reference axial direction.

16. The image-capturing method for correcting deviated viewing angle in image capturing of claim 11, further comprising:
collecting a plurality of the gravity-sensing inclination values by the image-capturing device, and calculating out an average value of the gravity-sensing inclination values after the second clipped picture is obtained; and
sensing a third sensitive pixel image by the image-capturing device, and reversely shifting the default image-capturing region reflected correspondingly to the third sensitive pixel image in accordance with the average value, and obtaining a third clipped picture by clipping the reversely shifted default image-capturing region from the third sensitive pixel image.

17. The image-capturing method for correcting deviated viewing angle in image capturing of claim 11, further comprising:
collecting a plurality of the gravity-sensing inclination values, and calculating out a calculation result of the gravity-sensing inclination values and a weight rule after the second clipped picture is obtained; and
sensing a third sensitive pixel image by the image-capturing device, reversely shifted the default image-capturing region reflected correspondingly to the third sensitive pixel image in accordance with the calculation result, and obtaining a third clipped picture by clipping the reversely shifted default image-capturing region from the third sensitive pixel image.

18. An image-capturing device for correcting deviated viewing angle in image capturing, comprising:
a main body;
an image capturing module pivotally disposed on the main body, and operated for capturing image frames with a default image-capturing viewing angle;
a driving unit coupled to the image capturing module, and operated for shifting an instant image-capturing viewing angle of the image capturing module;
a gravity sensing unit disposed on the main body, and operated for sensing a gravity-sensing inclination value of the main body; and
a processing unit electrically connected to the driving unit, the image capturing module and the gravity sensing unit,
wherein, whenever the processing unit determines that a difference magnitude exits between a reference axial direction and the gravity-sensing inclination value, the driving unit reversely shifts the instant image-capturing viewing angle of the image capturing module to become a corrected image-capturing viewing angle being at least partially overlapping the default image-capturing viewing angle in accordance with the difference magnitude, such that the image-capturing device is allowed to further continuously capture other image frames with the corrected image-capturing viewing angle.

19. The image-capturing device for correcting deviated viewing angle of claim 18, wherein the driving unit is a motor device or a solenoid valve.

20. An image-capturing device for correcting deviated viewing angle in image capturing, comprising:
an image capturing module operated for sensing a first sensitive pixel image;
a gravity sensing unit operated for collecting a gravity-sensing inclination value; and
a processing unit electrically connected to the image capturing module and the gravity sensing unit, and operated for obtaining a first clipped picture by clipping from the first sensitive pixel image in accordance with a default image-capturing region reflected correspondingly to the first sensitive pixel image,
wherein, when the processing unit determines that a difference magnitude exits between a reference axial direction and the gravity-sensing inclination value, the processing unit reversely shifts the default image-capturing region reflected correspondingly to a second sensitive pixel image sensed by the image capturing module in accordance with the difference magnitude, and obtains a second clipped picture by clipping the reversely shifted default image-capturing region from the second sensitive pixel image.
